(19) United States
(12) Patent Application Publication
(10) Pub. No.: US 2024/0214115 A1
(43) Pub. Date: Jun. 27, 2024

(54) METHOD AND APPARATUS FOR TRANSMITTING SIGNALS USING FREQUENCY HOPPING

(71) Applicant: ELECTRONICS AND TELECOMMUNICATIONS RESEARCH INSTITUTE, Daejeon (KR)

(72) Inventors: Soo Yeob JUNG, Daejeon (KR); Mi Kyung OH, Daejeon (KR); Joon Gyu RYU, Daejeon (KR); Sang Jae LEE, Daejeon (KR)

(73) Assignee: ELECTRONICS AND TELECOMMUNICATIONS RESEARCH INSTITUTE, Daejeon (KR)

(21) Appl. No.: 18/396,528

(22) Filed: Dec. 26, 2023

(30) Foreign Application Priority Data
Dec. 27, 2022 (KR) 10-2022-0186199

(51) Int. Cl. H04L 1/00; H04L 5/00; H04L 27/26

(52) U.S. Cl. CPC H04L 1/0061; H04L 1/0071; H04L 5/0012; H04L 27/2605

(57) ABSTRACT

A transmission device in a satellite IoT system may comprise: a CRC value generator that receives first data and generates and outputs a payload CRC value; a forward error correction encoder that receives second data consisting of the first data and the payload CRC value from the CRC value generator, and performs forward error correction coding on the second data; an interleaver that receives third data consisting of the forward error correction coded first data and the payload CRC value from the forward error correction encoder, and outputs interleaved payload blocks by performing cyclic shifts on the forward error correction coded first data based on offsets; and a frequency hopping unit that receives the interleaved payload blocks from the interleaver, and generates and transmits payload blocks frequency-hopped according to a hopping sequence.

### CROSS-REFERENCE TO RELATED APPLICATIONS

This application claims priority to Korean Patent Application No. 10-2022-0186199, filed on Dec. 27, 2022, with the Korean Intellectual Property Office (KIPO), the entire contents of which are hereby incorporated by reference.

### BACKGROUND

### 1. Technical Field

Exemplary embodiments of the present disclosure relate to a signal transmission technique using frequency hopping, and more specifically, to a frequency hopping-based signal transmission technique applying interleaving using offsets and frequency hopping boundaries where an idle period is configured.

### 2. Related Art

Internet of Things (IoT) technologies can connect various objects through the Internet. Additionally, IoT technologies allow connected objects to exchange information with each other, enabling remote control of the objects. IoT technologies can be implemented in various ways. For example, according to IoT technologies, a communication system may include multiple IoT terminals. In this case, IoT terminals may perform sensing operations as sensor nodes. Additionally, IoT terminals can be connected to relay nodes, such as low-orbit satellites, to transmit sensing data to the relay nodes. The sensing data transmitted to the relay node can then be transmitted to and utilized by a terrestrial base station, and the like.

In the context of IoT technologies, communication standards for satellite IoT can employ techniques such as frequency hopping, error correction coding, interleaving, and similar techniques to ensure robust performance in the face of interference between terminals. In this scenario, each terminal has the capability to partition transmission data into blocks within its designated frequency band and transmit the data through block-by-block frequency hopping. Consequently, each terminal can autonomously manage both the frequency bandwidth and center frequency utilized during the transmission process.

Meanwhile, the terminal can transmit information about hopping frequencies by incorporating it into a packet header. Subsequently, a gateway can receive a packet based on the hopping frequency information included in the packet header. In this scenario, individual terminals can transmit packets using distinct center frequencies and spreading bandwidths. When multiple terminals are concurrently transmitting data, interference between terminals may occur in certain blocks, leading to errors in the received data. To address such errors, the terminal can implement error correction coding on the transmission data and interleave the encoded data for distribution into packets, which are then transmitted. However, despite the signal processing described above, spurious noises may manifest at the boundaries of blocks transmitted by the terminals. In particular, if the last block transmitted from the terminal abruptly concludes without a designated transition period, distortion may arise in the last symbol due to signal processing, such as a low-pass filter in the receiver. Moreover, the error detection performance may not meet a desired confidence level.

### SUMMARY

Exemplary embodiments of the present disclosure are directed to providing a signal transmission method and apparatus using frequency hopping, which improve reception performance through interleaving using offsets and frequency hopping boundaries where an idle period is configured.

According to a first exemplary embodiment of the present disclosure, a transmission device in a satellite Internet of Things (IoT) system may comprise: a cyclic redundancy check (CRC) value generator that receives first data and generates and outputs a payload CRC value; a forward error correction encoder that receives second data consisting of the first data and the payload CRC value from the CRC value generator, and performs forward error correction coding on the second data; an interleaver that receives third data consisting of the forward error correction coded first data and the payload CRC value from the forward error correction encoder, and outputs interleaved payload blocks by performing cyclic shifts on the forward error correction coded first data based on offsets; and a frequency hopping unit that receives the interleaved payload blocks from the interleaver, and generates and transmits payload blocks frequency-hopped according to a hopping sequence.

The transmission device may further comprise: a whitening unit that receives a payload, performs whitening so that a sum of data of the payload approaches 0, and outputs the first data to the CRC value generator.

The interleaver may output the interleaved payload blocks by dividing the third data into N data groups, sequentially and respectively inputting values of the N data groups into N rows of an interleaver memory, sequentially and respectively outputting the values input to the N rows in a column direction, and performing cyclic shifts on the output values by using the offsets, wherein N is a positive integer.

The interleaver may apply the offsets differently to the column direction for the respective N rows.

The offset may be determined as max{1, 48/n}, where n is an index of the payload block, is equal to or greater than 0, and is equal to or less than N−1.

Padding may be added to at least one data group among the N data groups in order to equalize sizes of the N data groups.

The interleaver may perform cyclic shifts using the offsets to bits excluding the padding in the N data groups.

The transmission device may further comprise: a header generator that generates a packet header consisting of a synchronization word field, a physical header field, and a physical header CRC value field, and outputs the packet header to the frequency hopping unit, wherein the header generator may deliver some bits of a physical header CRC value to the frequency hopping unit by mapping the some bits to a reserved field of the physical header field, and may deliver remaining bits of the physical header CRC value to the frequency hopping unit by mapping the remaining bits to the physical header CRC value field.

The transmission device may further comprise: a transmitter that transmits the payload blocks frequency-hopped at the frequency hopping unit by considering an idle period, wherein the idle period has a length equal to or greater than at least one symbol.

According to a second exemplary embodiment of the present disclosure, a transmission method of a transmission device in a satellite Internet of Things (IoT) system may comprise: generating a payload cyclic redundancy check (CRC) value for first data; performing forward error correction coding on second data consisting of the first data and the payload CRC value; generating interleaved payload blocks by performing cyclic shifts on third data consisting of forward error correction coded first data and the payload CRC value based on offsets; and generating frequency-hopped payload blocks by performing frequency hopping on the interleaved payload blocks according to a hopping sequence, and transmitting the frequency-hopped payload blocks.

The generating of the interleaved payload blocks may comprise: dividing the third data into N data groups; sequentially and respectively inputting values of the N data groups into N rows of an interleaver memory; sequentially and respectively outputting the values input to the N rows in a column direction; and performing cyclic shifts on the output values by using the offsets, wherein N is a positive integer.

The transmission device may apply the offsets differently to the column direction for the respective N rows.

The offset may be determined as max{1, 48/n}, where n is an index of the payload block, is equal to or greater than 0, and is equal to or less than N−1.

Padding may be added to at least one data group among the N data groups in order to equalize sizes of the N data groups.

Cyclic shifts using the offsets may be applied to bits excluding the padding in the N data groups.

The transmission method may further comprise: generating a packet header consisting of a synchronization word field, a physical header field, and a physical header CRC value field; and performing frequency hopping on the packet header according to the hopping sequence, and transmitting the packet header, wherein some bits of a physical header CRC value are mapped to a reserved field of the physical header field, and remaining bits of the physical header CRC value are mapped to the physical header CRC value field.

In the transmitting of the frequency-hopped payload blocks, the frequency-hopped payload blocks may be transmitted considering an idle period, wherein the idle period has a length equal to or greater than at least one symbol.

According to the present disclosure, the interleaver of the transmission device can output interleaved payload blocks by performing cyclic shift on each data block by applying an offset to the data block. Also, the interleaver of the transmission device can apply different offsets to the respective payload blocks.

Furthermore, according to the present disclosure, the interleaver of the transmission device can divide a payload into data groups each having a predetermined number of bits in order to interleave the payload. Also, the interleaver of the transmission device can supplement insufficient bits with zeros when dividing the payload into data groups. Also, the interleaver of the transmission device may not perform cyclic shift on the zeros used to supplement the insufficient bits of the data groups.

Furthermore, according to the present disclosure, the transmission device can set an idle period having a length of at least one symbol or more when transmitting the payload blocks. As a result, the transmission device can suppress the occurrence of spurious noises.

Furthermore, according to the present disclosure, the transmission device can generate a CRC value for detecting reception bit errors in a header by using additional reserved bits. Consequently, the transmission device can enhance error detection reliability by using the CRC value in the additional reserved bits.

### BRIEF DESCRIPTION OF DRAWINGS

FIG. 1 is a conceptual diagram illustrating a first exemplary embodiment of a satellite IoT system.

FIG. 2 is a conceptual diagram illustrating a second exemplary embodiment of a satellite IoT system.

FIG. 3 is a block diagram illustrating a first exemplary embodiment of the entity constituting the satellite IoT system.

FIG. 4 is a structural diagram illustrating a first exemplary embodiment of an LR-FHSS packet.

FIG. 5 is a structural diagram illustrating a first exemplary embodiment of the physical header of FIG. 4.

FIG. 6 is a block diagram illustrating a first exemplary embodiment of a signal transmission device using frequency hopping.

FIG. 7 is a conceptual diagram illustrating a first exemplary embodiment of a payload block.

FIG. 8 is a conceptual diagram illustrating a first exemplary embodiment of an interleaver memory.

FIG. 9 is a graph illustrating the number of hard decision errors in a de-interleaver of a reception device.

FIG. 10 is a conceptual diagram illustrating a first exemplary embodiment of data groups each consisting of M bits.

FIG. 11 is a conceptual diagram illustrating a second exemplary embodiment of an interleaver memory.

FIG. 12 is a conceptual diagram illustrating a first exemplary embodiment of cyclic shift.

FIG. 13 is a block diagram illustrating a first exemplary embodiment of a signal reception device using frequency hopping.

FIG. 14 is a flowchart illustrating a first exemplary embodiment of a signal transmission method using frequency hopping.

FIG. 15 is a flowchart illustrating a first exemplary embodiment of a signal reception method using frequency hopping.

FIG. 16 is a graph illustrating reception performance of interleavers according to a first exemplary embodiment.

FIG. 17 is a graph illustrating reception performance of interleavers according to a second exemplary embodiment.

FIG. 18 is a graph illustrating reception performance of interleavers according to a third exemplary embodiment.

FIG. 19 is a graph illustrating reception performance of interleavers according to a fourth exemplary embodiment.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g., long-term evolution (LTE) communication network), a 5G communication network (e.g., new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

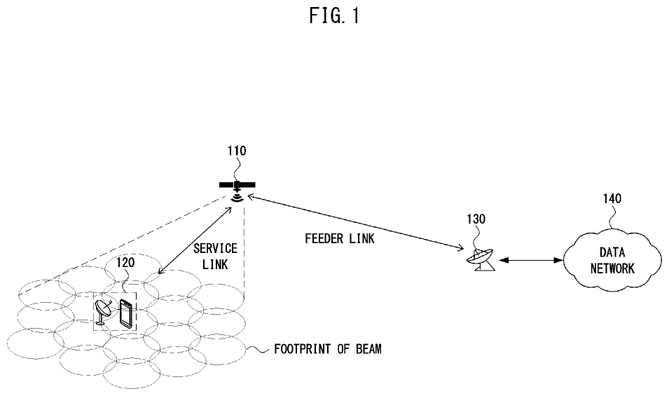

FIG. 1 is a conceptual diagram illustrating a first exemplary embodiment of a satellite IoT system.

Referring to FIG. 1, a satellite IoT system may include a satellite 110, a communication node 120, a gateway 130, a data network 140, and the like. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high-altitude platform station (HAPS). The communication node 120 may include an IoT terminal located on the ground. A service link may be established between the satellite 110 and the communication node 120, and the service link may be a radio link.

The communication node 120 may perform communication (e.g. downlink communication and uplink communication) with the satellite 110 using a long range-frequency hopping spread spectrum (LR-FHSS) technique.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g., AMF, UPF, SMF, and the like) may be performed based on an NG-C/U interface.

In such the IoT system, the IoT terminal, which is the communication node 120, may transmit data to the satellite 110 at a low data rate. Then, the satellite 110 may receive the data from the communication node 120 and demodulate the data. Thereafter, the satellite 110 may retransmit the demodulated data to the base station, and the base station may receive the demodulated data from the satellite 110 and utilize the demodulated data for further processing.

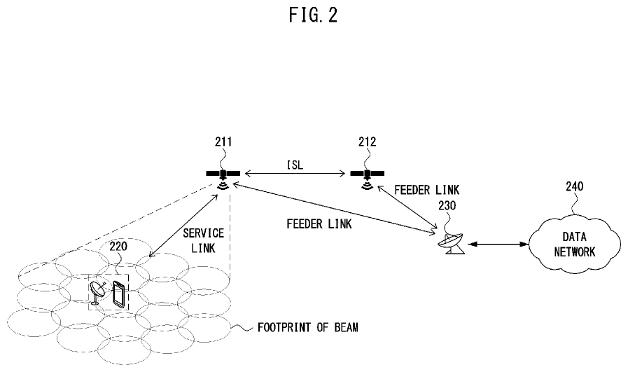

FIG. 2 is a conceptual diagram illustrating a second exemplary embodiment of a satellite IoT system.

Referring to FIG. 2, a satellite IoT system may include a first satellite 211, a second satellite 212, a communication node 220, a gateway 230, a data network 240, and the like. Each of the satellites 211 and 212 may be an LEO satellite, a MEO satellite, a GEO satellite, an HEO satellite, or a UAS platform. The satellite 211 may be connected with the satellite 212, and an inter-satellite link (ISL) may be established between the satellite 211 and the satellite 212. The ISL may operate in an RF frequency band or an optical band. The ISL may be established optionally. The communication node 220 may include an IoT terminal located on the ground. A service link (e.g. radio link) may be established between the satellite 211 and the communication node 220.

The communication node 220 may perform communication (e.g. downlink communication and uplink communication) with the satellite 211 using the LR-FHSS technique. The gateway 230 may be located on the ground, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be mandatorily established.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g., AMF, UPF, SMF, and the like) may be performed based on an NG-C/U interface.

In such the IoT system, the IoT terminal, which is the communication node 220, may transmit data to the satellite 211 at a low data rate. Then, the satellite 211 may receive the data from the communication node 220 and demodulate the data. Thereafter, the satellite 211 may retransmit the demodulated data to the base station through the satellite 212, and the base station may receive the demodulated data from the satellite 211 and utilize the demodulated data for further processing.

Meanwhile, the entities (e.g. satellite, communication node, gateway, etc.) constituting the satellite IoT system shown in FIGS. 1 and 2 may be configured as follows.

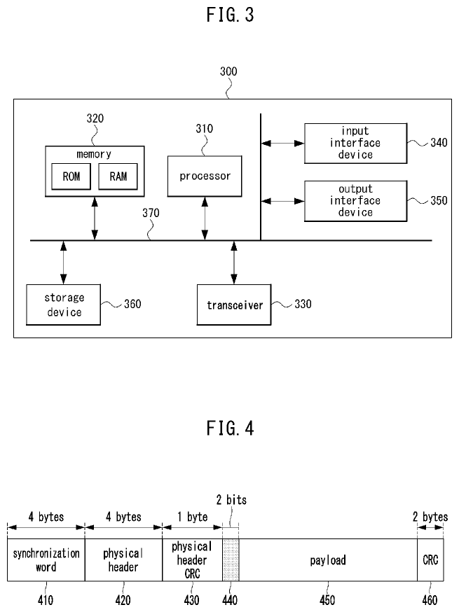

FIG. 3 is a block diagram illustrating a first exemplary embodiment of the entity constituting the satellite IoT system.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, the IoT technology can enable reliable wireless communication between distributed sensors and actuator devices using low-power wireless communication techniques and protocols. Over the past decade, low-power wide area network (LPWAN) technologies have been receiving a lot of attention in the communication technology field. In particular, a long range WAN (LoRaWAN) in the LPWAN technologies may be a field that attracts the most attention thanks to its long range and robust communication. The LoRaWAN may be a network architecture that allows for an easily deployable and manageable solution.

At a physical layer, the LoRaWAN can employ a long range (LoRa) which is a powerful chirp spread spectrum (CSS) modulation technique. The LoRa physical layer is designed to prioritize uplink communications and ensure low-power operation, limited by a low data rate (e.g. 250 bps in a 125 kHz channel with a spreading factor of 12). The LoRaWAN can utilize various configurations of the physical layer that provide different levels of chirp redundancy, allowing tradeoffs between bandwidth utilization and robustness. The LoRaWAN can define various bandwidth configurations ranging from 125 kHz to 500 kHz per channel, depending on regional parameters and available bandwidth.

The LoRaWAN as descried above can be widely used. However, the LoRaWAN may have drawbacks and limitations, especially in dense deployments where performance (i.e. overall network capacity) is severely limited by duty cycle regulations and the use of simple medium access control (MAC) protocols.

In that sense, the research community has published several proposals over the past few years to address the basic operation of LoRaWAN at the physical and data link layers as well as the overall system operation using both analytical models and simulations. Additionally, scalability and reliability issues in LoRaWAN have been the focus of recent research efforts on ensuring fairness, improving channel usage, or scheduling LoRa transmissions.

Meanwhile, the LR-FHSS technique has been recently announced as an extension of the LoRa physical layer. This extension may be motivated by new use cases with increasingly larger and denser network deployments, including satellite-scale LoRaWAN networks. The main goal of LR-FHSS technique is to be able to maintain the same communication range as LoRa by adopting a FHSS modulation technique to increase network capacity and robustness, while satisfying regulations of European Telecommunications Standards Institute (ETSI), Federal Communications Commission (FCC), and Association of radio industries and businesses (ARIB). Additionally, the LR-FHSS is designed to introduce a higher level of network flexibility targeting applications that require differentiated service levels. The LR-FHSS can have a significant impact on LPWAN and is expected to enable viable satellite IoT solutions.

The LoRaWAN can designate a priority for uplink capacity and limit downlink transmission to sporadic data or control packets. The LR-FHSS may be a fast FHSS modulation used exclusively for uplink. Downlink communication can currently be achieved by the current LoRa because the same radio signal can switch between modulation schemes. The LR-FHSS may rely on two bit rates (i.e. 162 and 325 bps) depending on a new LoRaWAN data rate (DR) mode. To initiate packet transmission, an end device may randomly select one of available LR-FHSS channels.

In the LR-FHSS technique, a channel is divided into several sub-channels and a transmitter can use the sub-channels to change a carrier frequency for each transmission hop according to a specific hopping pattern. First, multiple replicas of a packet header may be transmitted. The number of replicas may be defined according to each LR-FHSS DR. Then, a packet payload may be divided into fragments each having a duration of ˜50 ms. Here, each of the divided pieces of the packet payload may be a payload block. Unlike the packet header, only a single replica of each payload block may be transmitted. The packet header and all the payload blocks may be transmitted continuously on the sub-channels respectively determined by a frequency hopping sequence of the transmitter. At the other end, a receiver can use information within the packet header to reconstruct the packet payload by using the payload blocks.

Unlike the LoRa channels, since the LR-FHSS transmission is entirely within the receiver's processing bandwidth, allowing packets to be demodulated. As a result, the receiver may not need to know the channel hopping sequence, exact channel frequency, and bandwidth in advance. Therefore, different devices may use different spreading bandwidths and may not all have channels at the same frequency. It may also mean that multiple transmitters can use different channel hopping sequences, and that multiple transmitters can operate simultaneously if the receiver can receive the entire channel bandwidth at a time. This may increase the complexity of signal detection at the receiver compared to LoRa. However, because hundreds of packets can be received simultaneously, it could be suitable for satellite-scale networks where the number of interfering devices within a coverage of a space-located receiver is much higher than the number of devices found in the current LoRaWAN use cases.

FIG. 4 is a structural diagram illustrating a first exemplary embodiment of an LR-FHSS packet.

Referring to FIG. 4, an LR-FHSS packet may include a 4-byte synchronization word (i.e. syncword) 410, a 4-byte physical header 420, a 1-byte physical header cyclic redundancy check (CRC) value 430, a shaded gray section 440, a payload 450, and a 2-byte payload CRC value 460. Here, the synchronization word, physical header, and physical header CRC vale may constitute a packet header. In addition, the payload and the payload CRC value may constitute a packet payload.

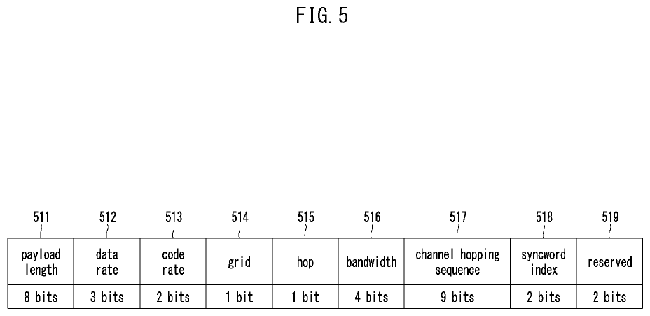

FIG. 5 is a structural diagram illustrating a first exemplary embodiment of the physical header of FIG. 4.

Referring to FIG. 5, the physical header may include an 8-bit payload length field 511, a 3-bit data rate field 512, a 2-bit code rate field 513, a 1-bit grid field 514, a 1-bit hop field 515, a 4-bit bandwidth field 516, a 9-bit channel hopping sequence field 517, a 2-bit syncword index field 518, and a 2-bit reserved field 519.

The packet header may include information required for a reception device to calculate an exact list of frequencies to use for the packet. Therefore, the reception device can detect the packet and receive at least one replica of the packet header for reassembly. The packet header may be longer than ˜50 ms but may not be divided into multiple pieces.

The payload blocks may constitute the payload and may be transmitted at a configured data rate. The original information can be encoded in a way that even if a third of the payload blocks are lost, the original information can still be recovered and the packets can be reassembled with a high probability. Additionally, the LR-FHSS technique allows various selections of modulation per packet, number of header repetitions, code rate, and frequency spread bandwidth. This can enable granular network resource management based on link quality that can reach a quality of service (QoS) required for each device.

Similarly to the LoRaWAN, a frequency band may be divided into different operating channel width (OCW) channels. The number of available channels depends on the region in which the network operates, so a white-list can be used to represent these channels. For example, in North America, the specification defines eight LR-FHSS OCW channels each having a bandwidth of 1.523 MHz. The center frequency thereof may be (903+1.6 n) MHz. Here, n may be 0 to 7.

In Europe, the LR-FHSS OCW channel may be defined to have a bandwidth such as 137 kHz or 336 kHz depending on a selected DR. The number of available channels may vary depending on a specific receiver technology used by a network operator. The number of LR-FHSS channels supported by the receiver depends on the number of digital signal processors (DSPs) used, and each DSP can process a bandwidth of 1.523 MHz. For example, an end device using a receiver with one DSP and 200 kHz channel spacing can use up to seven LR-FHSS channels when using the 137 kHz OCW channel for uplink.

Each LR-FHSS OCW channel may be divided into several occupied band width (OBW) physical channel subcarriers each having a bandwidth of 488 Hz. A subcarrier hopping policy may have minimum frequency hops because local regulations place limits on time and bandwidth occupancy. That is, two consecutive subcarriers of a hopping sequence may be separated by a minimum distance. For each uplink packet, the device may randomly select a channel from among active channels that can support a data rate. Transmissions may be started from an arbitrary physical subchannel (grid) within the LR-FHSS spread bandwidth, and then may follow a pseudo-random frequency hopping pattern calculated by the device. Given a specific OCW frequency offset, the hopping pattern may be obtained based on a result of a simple 32-bit hash function executed by the LR-FHSS device, the number of channels available in a modulo grid, or the physical subcarriers available for channel hopping per end device.

In particular, the input of the hash function may be determined as a result of multiplying a device-specific 9-bit random number by a current fragment number and 216. Finally, the hash may be multiplied by the minimum frequency separation between LR-FHSS hopping carriers to comply with the regulations of the transmission band.

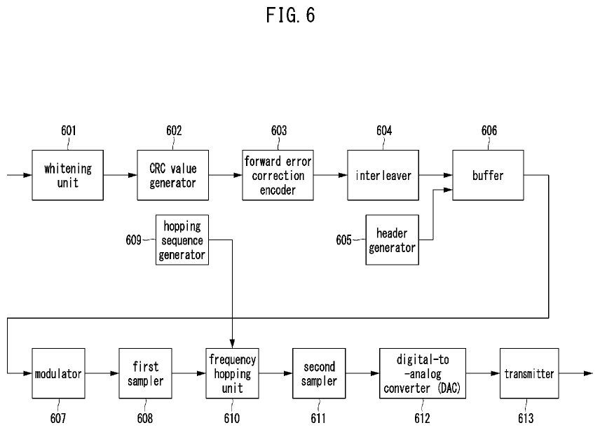

FIG. 6 is a block diagram illustrating a first exemplary embodiment of a signal transmission device using frequency hopping.

Referring to FIG. 6, a signal transmission device using frequency hopping may include a whitening unit 601, a CRC value generator 602, a forward error correction encoder 603, an interleaver 604, a header generator 605, a buffer 606, a modulator 607, a first sampler 608, a hopping sequence generator 609, a frequency hopping unit 610, a second sampler 611, a digital-to-analog converter (DAC) 612, and a transmitter 613.

The whitening unit 601 may receive data constituting a payload. Then, the whitening unit 601 may perform whitening on the received data constituting the payload so that a sum of the data approaches 0, and output the whitened data. Then, the CRC value generator 602 may receive the whitened data constituting the payload from the whitening unit 601, and generate and output a payload CRC value (e.g. 16-bit CRC value) of the payload.

The forward error correction encoder 603 may receive data comprising the whitened data constituting the payload and the payload CRC value from the CRC value generator 602, perform forward error correction coding thereon, and output forward error correction coded data. For example, the forward error correction encoder 603 may convert each bit of the data output from the CRC value generator 602 into 3 bits as output.

The interleaver 604 may receive data consisting of the forward error correction coded payload and the payload CRC value from the forward error correction encoder 603, perform interleaving thereon to generate payload blocks, and output the payload blocks to the buffer 606.

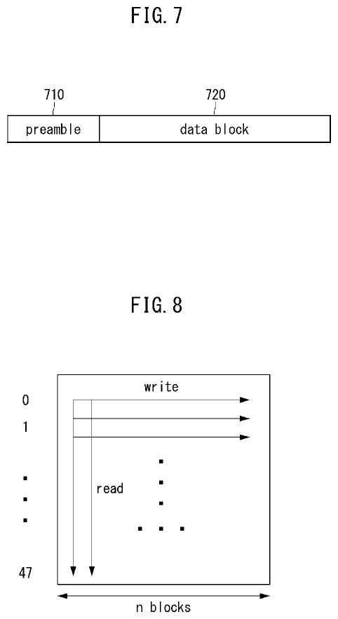

FIG. 7 is a conceptual diagram illustrating a first exemplary embodiment of a payload block.

Referring to FIG. 7, a payload block may include a 2-bit preamble 710 and a 48-bit data block 720.

FIG. 8 is a conceptual diagram illustrating a first exemplary embodiment of an interleaver memory.

Referring to FIG. 8, an interleaver memory may write data in the row direction (i.e. horizontal direction). Thereafter, the interleaver memory may read 48 rows of data in the column direction (i.e. vertical direction) and output n data blocks. Here, n may be a positive integer.

Referring again to FIG. 6, the interleaver 604 may write data in the row direction to the interleaver memory. Then, the interleaver 604 may read 48 rows of data in the column direction from the interleaver memory, and output n data blocks. In addition, the interleaver 604 may generate a 2-bit preamble and add the generated 2-bit preamble to each interleaved data block to form n payload blocks.

In this case, the payload block may end immediately after the last symbol without a separate transition period. Because of this, the last symbol of the payload block may not avoid distortion due to signal processing by a low pass filter of the reception device. As a result, soft bits of the last symbol of each payload block de-interleaved at the reception device may be concentrated and located in the last part of the packet at the input of the forward error correction decoder. As a result, error correction performance may deteriorate significantly at the forward error correction decoder.

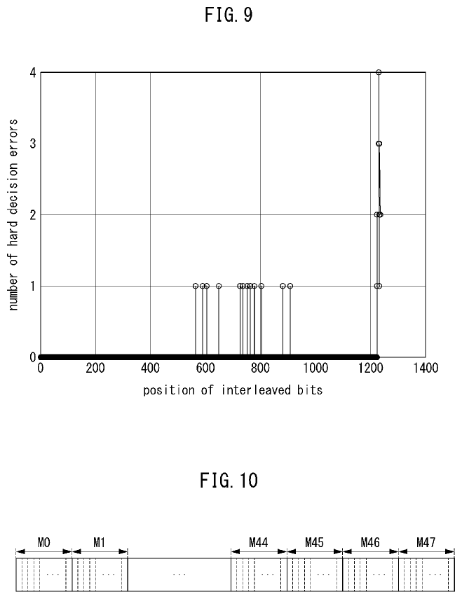

FIG. 9 is a graph illustrating the number of hard decision errors in a de-interleaver of a reception device.

Referring to FIG. 9, the number of hard decision errors may be a result of counting hard decision errors for each bit position of the output of the de-interleaver. In this case, a code rate may be 2/3, Es/No (i.e. energy per bit to noise spectral density ratio) may be 10 dB, and the number of packets may be 10 packets each having 100 bytes. It can be seen that hard decision errors occur as being concentrated on the bits of the last part of the packet.

Referring again to FIG. 6, the interleaver 604 may receive the data consisting of the forward error correction coded payload and the payload CRC value from the forward error correction encoder 603, and generate 48 data groups each consisting of M bits. Here, M may be a positive integer.

FIG. 10 is a conceptual diagram illustrating a first exemplary embodiment of data groups each consisting of M bits.

Referring to FIG. 10, data groups each may be composed of M bits. There may be 48 such the data groups. The interleaver may receive data consisting of the forward error correction coded payload and the payload CRC value from the forward error correction encoder, and may form 48 data groups each consisting of M bits. Here, M may be a positive integer.

In this situation, the amount of data received from the forward error correction encoder may be insufficient to form 48 data groups each consisting of M bits. To solve this, the interleaver may supplement the missing bits with ‘0’ to form each of 48 data groups. That is, the interleaver may sequentially form the data groups using the data received from the forward error correction encoder. In this case, as a result obtained by the interleaver forming data groups using all the data received from the forward error correction encoder, the number of data groups may not be 48.

In this case, although the interleaver has used all the data received from the forward error correction encoder, data group(s) whose configuration has not been completed may exist. In this case, the remaining bits of such data group(s) may be supplemented with 0. In addition, although the interleaver has used all the data received from the forward error correction encoder, data group(s) whose configuration has not been started may exist. In this case, all bits of such data group(s) may be supplemented with 0. In the above-described manner, the zeros used by the data groups to make up for missing bits may be referred to as ‘zero padding’.

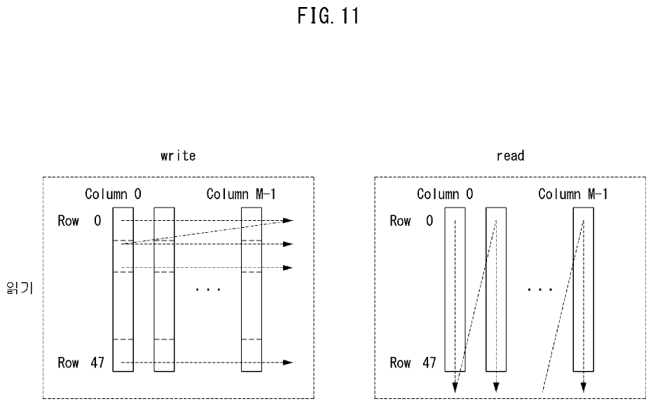

FIG. 11 is a conceptual diagram illustrating a second exemplary embodiment of an interleaver memory.

Referring to FIG. 11, the interleaver may write a first data group M0 in the first column (i.e. column 0) to the M-th column (i.e. column M−1) of the first row (i.e. row 0) of the interleaver memory. Then, the interleaver 604 may write a second data group M1 to the first column to the M-th column of the second row of the interleaver memory. In the above-described manner, the interleaver 604 may write a 48-th data group M47 in the first column to the M-th column of the 48-th row (i.e. row 47) of the interleaver memory.

Meanwhile, the interleaver may read bits written in each column of the plurality of rows in the column direction, and output them as a corresponding payload block. In this case, in order to improve performance degradation, the interleaver may set a corresponding offset for each payload block, and may perform cyclic shift on each data block by using the corresponding offset. Then, the interleaver may output cyclically-shifted payload blocks. In this case, the interleaver may arrange zeros (zero padding), which are used to compensate for insufficient data, at the end of the payload block, so as to prevent the zeros from being cyclically shifted. For example, the offset may be max{1, 48/n}. Here, n may be the index of the data block and may be a positive integer.

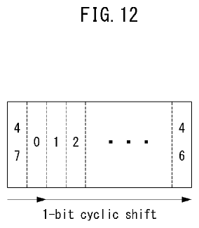

FIG. 12 is a conceptual diagram illustrating a first exemplary embodiment of cyclic shift.

Referring to FIG. 12, when the interleaver performs cyclic shift on each payload block, an order of bits within the payload block may be changed. For example, in case of a 1-bit cyclic shift, the zero-th bit of the payload block may be replaced with the 47-th bit, and the bits may continue to shift to the right. That is, the bits located at the 0-th, first, second, . . . , and 47-th positions in the payload block may be cyclically shifted to the right by 1 bit, and the bit located at the 47-th position before performing the cyclic shift may be located at the foremost of the data block, and the bits that located at the 0th, first, second, . . . , and 47-th positions may be sequentially shifted to the right by 1 bit.

In this case, the interleaver may apply a different offset to each payload block. That is, the interleaver may rearrange the order of bits within each payload block by cyclically shifting the each payload block by a different number of bits. In this case, in order to improve performance degradation, the interleaver may perform a cyclic shift by the offset for each payload block.

Referring again to FIG. 6, the header generator 605 may generate the packet header including the synchronization word, physical header, and physical header CRC value, and output the packet header to the buffer 606. In this case, the header generator 605 may generate an 8-bit physical header CRC value and output it to the buffer 606. Alternatively, the header generator 605 may generate a 10-bit physical header CRC value. In this case, the header generator 605 may output an 8-bit physical header CRC value to the buffer 606 by using a physical header CRC value field. Additionally, the header generator 605 may output a 2-bit physical header CRC value to the buffer 606 by using 2 bits of the reserve field.

That is, the header generator 605 may output 8 bits of the physical header CRC value to the buffer 606 using the physical header CRC value field. Additionally, the header generator 605 may output 2 bits of the physical header CRC value to the buffer 606 by using the reserved field. In the above-described manner, error detection reliability can be increased if the header generator 605 generates and uses the 10-bit physical CRC value by additionally using the 2-bit reserved field.

Meanwhile, the buffer 606 may receive the payload blocks from the interleaver 604, temporarily store them, and then output them to the modulator 607. In addition, the buffer 606 may receive the packet header generated by the header generator 605, temporarily store it, and then output it to the modulator 607.

Meanwhile, the modulator 607 may receive the packet header or payload blocks from the buffer 606. Then, the modulator 607 may perform Gaussian minimum shift keying (GMSK) modulation on the packet header or payload blocks, and transmit the GMSK-modulated packet header or payload blocks to the first sampler 608. Here, the GMSK scheme may be a type of minimum shift keying (MSK) schemes, which smoothes a phase variation by using a Gaussian pulse shaping filter, thereby reducing a change in binary data, and reduce a bandwidth of the modulated signal by removing a change in binary data.

Then, the first sampler 608 may receive the packet header or payload blocks modulated by the modulator 607, sample them at a sampling frequency, convert them into digital signals, and output them. Here, the first sampler 608 may perform up-sampling thereon to generate more signals by increasing samples.

Meanwhile, the hopping sequence generator 609 may store a plurality of hopping sequences. Additionally, the hopping sequence generator 609 may select one of the plurality of stored hopping sequences, and provide the selected sequence to the frequency hopping unit 610.

Then, the frequency hopping unit 610 may receive the packet header or payload blocks from the first sampler 608. Additionally, the frequency hopping unit 610 may receive a hopping sequence from the hopping sequence generator 609. Accordingly, the frequency hopping unit 610 may select a hopping frequency according to the hopping sequence, perform frequency hopping according to the selected hopping frequency, and output the packet header or payload blocks.

Then, the second sampler 611 may re-sample the packet header or payload blocks frequency-hopped by the frequency hopping unit 610 at a sampling frequency and output the sampled data to the digital-to-analog converter 612. In this case, the second sampler 611 may perform up-sampling to generate more signals by increasing samples.

Then, the digital-to-analog converter 612 may receive digital signals of the packet header and payload blocks sampled by the second sampler 611, convert them into analog signals, and output them to the transmitter 613. Accordingly, the transmitter 613 may receive the packet header converted into an analog signal by the digital-to-analog converter 611, and transmit the received packet header to a reception device. Additionally, the transmitter 613 may receive the payload blocks converted into analog signals by the digital-to-analog converter 611, and transmit the received payload blocks to the reception device. In this case, each payload block may be composed of a preamble and a data block. The timing of frequency adjustment for hopping may be, for example, between the last symbol of the payload block and the first symbol of the preamble of the next payload block.

Meanwhile, a time required for the frequency adjustment may be equal to or longer than a symbol length to suppress generation of spurious noises. Therefore, if there is no time interval between the last symbol of the payload block and the first symbol of the preamble of the next payload block, distortion may be introduced to the last symbol of the payload block or the first symbol of the preamble of the next payload block.

In order to prevent such performance degradation, the transmission device may require improvements to a configured frequency hopping boundary. Accordingly, the present disclosure proposes a method of setting a frequency hopping boundary having a length equal to or greater than at least one symbol. That is, the frequency adjustment may occur for at least one symbol length, and the signal of the next payload block may be transmitted later at the changed frequency.

To this end, the transmitter 613 may configure an idle period between the payload blocks. Additionally, the transmitter 613 may transmit the payload blocks with the configured idle period between the payload blocks. That is, the transmitter 613 may transmit the next payload block after the idle period elapses from the time of transmitting the payload block. Here, the idle period may have a length corresponding to at least one symbol or more.

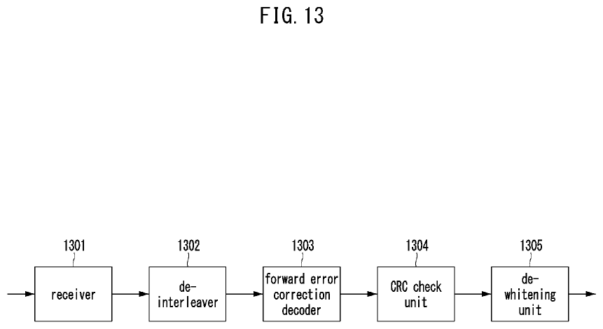

FIG. 13 is a block diagram illustrating a first exemplary embodiment of a signal reception device using frequency hopping.

Referring to FIG. 13, a signal reception device using frequency hopping may include a receiver 1301, a de-interleaver 1302, a forward error correction decoder 1303, a CRC check unit 1304, and a de-whitening unit 1305.

The receiver 1301 may receive the packet header transmitted from the transmission device. In addition, the receiver 1301 may receive the payload blocks based on the received packet header. Then, the de-interleaver 1302 may receive the payload blocks from the receiver 1301, and perform deinterleaving on the received payload blocks to restore data consisting of the forward error correction coded payload and the payload CRC value. Here, the deinterleaving process may be a process opposite to the interleaving process described above.

The forward error correction decoder 1303 may receive the data consisting of the forward error correction coded payload and the payload CRC value from the de-interleaver 1302, and perform forward error correction on the forward error correction coded payload to output data consisting of a forward error corrected payload and the payload CRC value. For example, the forward error correction decoder 1303 may convert each unit of 3 bits of the received data into 1 bit.

Then, the CRC check unit 1304 may receive the data consisting of the forward error corrected payload and the payload CRC value, and perform a CRC check using the payload CRC value to check for errors in the payload. The CRC check unit 1304 may perform the CRC check and output a payload for which the CRC check has been completed. Thereafter, the de-whitening unit 1305 may receive the payload for which the CRC check has been completed from the CRC check unit 1304, perform de-whitening thereon, and output a de-whitened payload. The de-whitening process may be a process opposite of the whitening process described above.

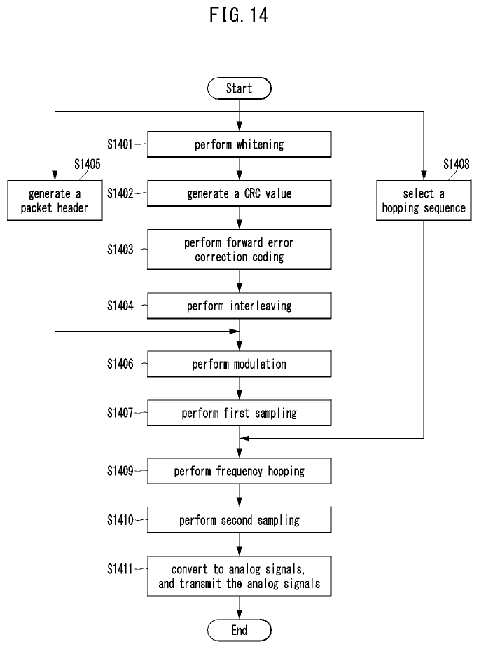

FIG. 14 is a flowchart illustrating a first exemplary embodiment of a signal transmission method using frequency hopping.

Referring to FIG. 14, in a signal transmission method using frequency hopping, the whitening unit may receive data constituting the payload, and perform whitening thereon so that a sum of the data approaches 0 (S1401). Then, the CRC value generator may receive data constituting the whitened payload from the whitening unit, and generate and output the payload CRC value (e.g. 16-bit CRC value) (S1402).

Meanwhile, the forward error correction encoder may receive data consisting of the payload and the payload CRC value from the CRC value generator, perform forward error correction coding thereon, and output the data (S1403). For example, the forward error correction encoder may covert each bit of the data output from the CRC value generator into 3 bits.

The interleaver may receive data consisting of the forward error correction coded payload and the payload CRC value from the forward error correction encoder, and perform interleaving thereon to generate and output payload blocks. In this case, each payload block may consist of a 2-bit preamble and a 48-bit data block. Describing this in more detail, the interleaver may write the data in the row direction to the interleaver memory. Then, the interleaver may read 48 rows of data in the column direction from the interleaver memory, and output n data blocks. In addition, the interleaver may generate a 2-bit preamble and add the generated 2-bit preamble to each interleaved data block to form n payload blocks. The interleaver may receive data consisting of the forward error correction coded payload and the payload CRC value from the forward error correction encoder, and may form 48 data groups each consisting of M bits. Here, M may be a positive integer.

In this situation, the amount of data received from the forward error correction encoder may be insufficient to form 48 data groups each consisting of M bits. To solve this, the interleaver may supplement the missing bits with ‘0’ to form each of 48 data groups. That is, the interleaver may sequentially form the data groups using the data received from the forward error correction encoder. In this case, as a result obtained by the interleaver forming data groups using all the data received from the forward error correction encoder, the number of data groups may not be 48.

Although the interleaver has used all the data received from the forward error correction encoder, data group(s) whose configuration has not been completed may exist. In this case, the remaining bits of such data group(s) may be supplemented with 0. In addition, although the interleaver has used all the data received from the forward error correction encoder, data group(s) whose configuration has not been started may exist. In this case, all bits of such data group(s) may be supplemented with 0. In the above-described manner, the zeros used by the data groups to make up for missing bits may be referred to as ‘zero padding’.

Meanwhile, the interleaver may read bits written in each column of a plurality of rows in the column direction, and output them as payload blocks. In this case, in order to improve performance degradation, the interleaver may set a corresponding offset for each payload block, and may perform cyclic shift on each data block by using the corresponding offset. Then, the interleaver may output cyclically-shifted payload blocks. In this case, the interleaver may arrange zeros (zero padding), which are used to compensate for insufficient data, at the end of the payload block, so as to prevent the zeros from being cyclically shifted. For example, the offset may be max{1, 48/n}. Here, n may be the index of the data block and may be a positive integer.

Meanwhile, the header generator may generate and output a packet header including a synchronization word, physical header, and physical header CRC value (S1405). In this case, the header generator may generate an 8-bit physical header CRC value and output it. Alternatively, the header generator may generate a 10-bit physical header CRC value. In this case, the header generator may output an 8-bit physical header CRC value by using the physical header CRC value field. Additionally, the header generator 605 may output a 2-bit physical header CRC value by using 2 bits of the reserve field. That is, the header generator may output 8 bits of the physical header CRC value using the physical header CRC value field. Additionally, the header generator may output 2 bits of the physical header CRC value by using the reserved field.

Meanwhile, the modulator may receive the packet header from the header generator, and receive the payload blocks from the interleaver. The modulator may perform Gaussian minimum shift keying (GMSK) modulation on the packet header or payload blocks and output the GMSK-modulated packet header or payload blocks to the first sampler (S1406).

Then, the first sampler may receive the packet header or payload blocks modulated by the modulator, and output them by performing first sampling thereon at a sampling frequency to convert them into digital signals (S1407). Here, the first sampler may perform up-sampling to generate more signals by increasing samples.

Meanwhile, the hopping sequence generator may store a plurality of hopping sequences. Additionally, the hopping sequence generator may select one from the plurality of stored hopping sequences, and provide the selected sequence to the frequency hopping unit (S1408).

The frequency hopping device unit may receive the packet header or payload blocks from the first sampler. Additionally, the frequency hopping unit may receive the hopping sequence from the hopping sequence generator. Accordingly, the frequency hopping unit may select a hopping frequency according to the hopping sequence, and output the packet header or payload blocks by performing frequency hopping thereon according to the selected hopping frequency (S1409).

The second sampler may perform second sampling on the packet header or payload blocks frequency-hopped by the frequency hopping unit at a sampling frequency, and output the samples to the digital-to-analog converter (S1410). Here, the second sampler may perform up-sampling to generate more signals by increasing samples.

The digital-to-analog converter may receive digital signals of the packet header and payload blocks sampled by the second sampler, convert them into analog signals, and output them to the transmission unit. Accordingly, the transmission unit may receive the packet header converted into an analog signal by the digital-to-analog converter and transmit the received packet header to the reception device (S1411). Additionally, the transmitter may receive payload blocks converted into analog signals by the digital-to-analog converter and transmit the received payload blocks to the reception device. In this case, each payload block may be composed of a preamble and data. The timing of frequency adjustment for hopping may be, for example, between the last symbol of the payload block and the first symbol of the preamble of the next payload block. In this case, the transmission unit may configure an idle period between the payload blocks. Additionally, the transmission unit may transmit the payload blocks with the configured idle period between the payload blocks. That is, the transmission unit may transmit the next payload block after the idle period elapses from a time of transmitting one payload block. Here, the idle period may have a length corresponding to at least one symbol or more.

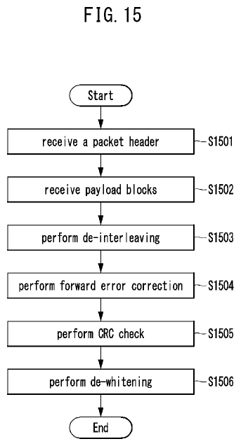

FIG. 15 is a flowchart illustrating a first exemplary embodiment of a signal reception method using frequency hopping.

Referring to FIG. 15, in a signal reception method using frequency hopping, the receiver may receive a packet header transmitted from the transmission device (S1501). In addition, the receiver may receive payload blocks based on the received packet header (S1502). Then, the de-interleaver may receive the payload blocks from the receiver, and perform deinterleaving on the received payload blocks to restore data consisting of the forward error correction coded payload and the payload CRC value (S1503). Here, the deinterleaving process may be a process opposite to the interleaving process described above.

Meanwhile, the forward error correction decoder may receive data consisting of the forward error correction coded payload and payload CRC value from the de-interleaver, and performs forward error correction thereon to output the forward error correction coded payload and payload CRC value into the forward error correction decoder (S1504). For example, the forward error correction decoder may convert each unit of 3 bits of the received data into 1 bit.

Then, the CRC check unit may receive the data consisting of the forward error corrected payload and the payload CRC value, and perform a CRC check using the payload CRC value to check for errors in the payload (S1505). The CRC check unit may perform the CRC check and output a payload for which the CRC check has been completed. Thereafter, the de-whitening unit may receive the payload for which the CRC check has been completed from the CRC check unit, and output a de-whitened payload by performing de-whitening thereon. The de-whitening process may be a process opposite of the whitening process described above.

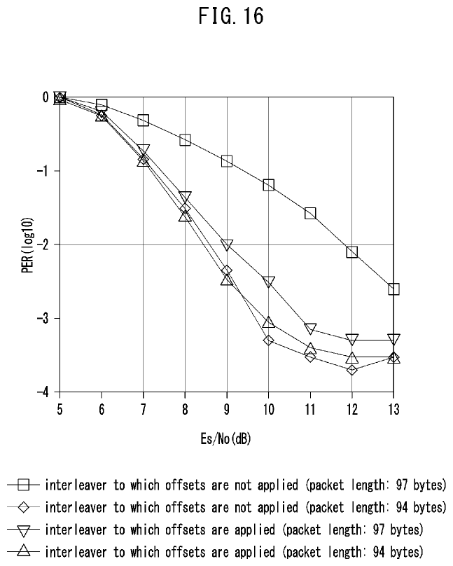

FIG. 16 is a graph illustrating reception performance of interleavers according to a first exemplary embodiment.

Referring to FIG. 16, an interleaver to which an offset is not applied may have a large performance difference between a packet having a length of 97 bytes and a packet having a length of 94 bytes. In contrast, an interleaver to which an offset is applied may have a small performance difference between the packet having a length of 97 bytes and the packet having a length of 94 bytes. This may be because distortion of the last symbol of the payload block can be recovered through error correction decoding. Here, a code rate may be 5/6. Also, the horizontal axis may represent Es/No (db), and the vertical axis may represent a packet error rate (PER).

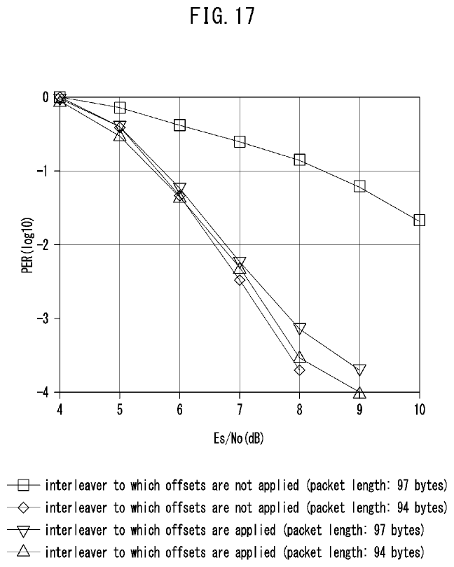

FIG. 17 is a graph illustrating reception performance of interleavers according to a second exemplary embodiment.

Referring to FIG. 17, an interleaver to which an offset is not applied may have a large performance difference between a packet having a length of 97 bytes and a packet having a length of 94 bytes. In contrast, an interleaver to which an offset is applied may have a small performance difference between the packet having a length of 97 bytes and the packet having a length of 94 bytes. This may be because distortion of the last symbol of the payload block can be recovered through error correction decoding. Here, a code rate may be 2/3. Also, the horizontal axis may represent Es/No (db), and the vertical axis may represent a PER.

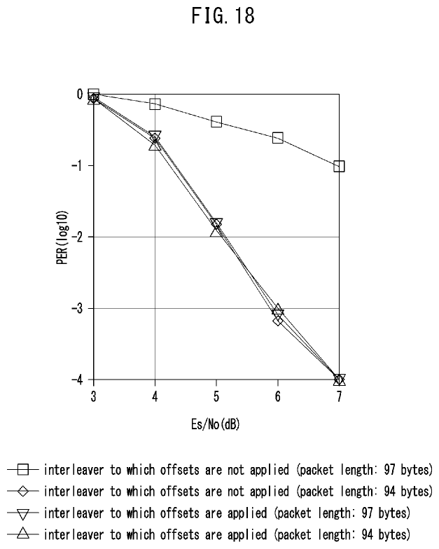

FIG. 18 is a graph illustrating reception performance of interleavers according to a third exemplary embodiment.

Referring to FIG. 18, an interleaver to which an offset is not applied may have a large performance difference between a packet having a length of 97 bytes and a packet having a length of 94 bytes. In contrast, an interleaver to which an offset is applied may have a small performance difference between the packet having a length of 97 bytes and the packet having a length of 94 bytes. This may be because distortion of the last symbol of the payload block can be recovered through error correction decoding. Here, a code rate may be 1/2. Also, the horizontal axis may represent Es/No (db), and the vertical axis may represent a PER.

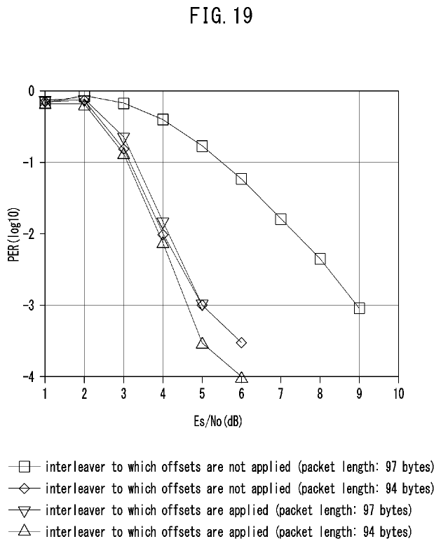

FIG. 19 is a graph illustrating reception performance of interleavers according to a fourth exemplary embodiment.

Referring to FIG. 19, an interleaver to which an offset is not applied may have a large performance difference between a packet having a length of 97 bytes and a packet having a length of 94 bytes. In contrast, an interleaver to which an offset is applied may have a small performance difference between the packet having a length of 97 bytes and the packet having a length of 94 bytes. This may be because distortion of the last symbol of the payload block can be recovered through error correction decoding. Here, a code rate may be 1/3. Also, the horizontal axis may represent Es/No (db), and the vertical axis may represent a PER.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A transmission device in a satellite Internet of Things (IoT) system, comprising:
a cyclic redundancy check (CRC) value generator that receives first data and generates and outputs a payload CRC value;
a forward error correction encoder that receives second data consisting of the first data and the payload CRC value from the CRC value generator, and performs forward error correction coding on the second data;
an interleaver that receives third data consisting of the forward error correction coded first data and the payload CRC value from the forward error correction encoder, and outputs interleaved payload blocks by performing cyclic shifts on the forward error correction coded first data based on offsets; and
a frequency hopping unit that receives the interleaved payload blocks from the interleaver, and generates and transmits payload blocks frequency-hopped according to a hopping sequence.

2. The transmission device according to claim 1, further comprising: a whitening unit that receives a payload, performs whitening so that a sum of data of the payload approaches 0, and outputs the first data to the CRC value generator.

3. The transmission device according to claim 1, wherein the interleaver outputs the interleaved payload blocks by dividing the third data into N data groups, sequentially and respectively inputting values of the N data groups into N rows of an interleaver memory, sequentially and respectively outputting the values input to the N rows in a column direction, and performing cyclic shifts on the output values by using the offsets, wherein N is a positive integer.

4. The transmission device according to claim 3, wherein the interleaver applies the offsets differently to the column direction for the respective N rows.

5. The transmission device according to claim 4, wherein the offset is determined as max{1, 48/n}, where n is an index of the payload block, is equal to or greater than 0, and is equal to or less than N−1.

6. The transmission device according to claim 4, wherein padding is added to at least one data group among the N data groups in order to equalize sizes of the N data groups.

7. The transmission device according to claim 6, wherein the interleaver performs cyclic shifts using the offsets to bits excluding the padding in the N data groups.

8. The transmission device according to claim 1, further comprising: a header generator that generates a packet header consisting of a synchronization word field, a physical header field, and a physical header CRC value field, and outputs the packet header to the frequency hopping unit, wherein the header generator delivers some bits of a physical header CRC value to the frequency hopping unit by mapping the some bits to a reserved field of the physical header field, and delivers remaining bits of the physical header CRC value to the frequency hopping unit by mapping the remaining bits to the physical header CRC value field.

9. The transmission device according to claim 1, further comprising: a transmitter that transmits the payload blocks frequency-hopped at the frequency hopping unit by considering an idle period, wherein the idle period has a length equal to or greater than at least one symbol.

10. A transmission method of a transmission device in a satellite Internet of Things (IoT) system, comprising:
generating a payload cyclic redundancy check (CRC) value for first data;
performing forward error correction coding on second data consisting of the first data and the payload CRC value;
generating interleaved payload blocks by performing cyclic shifts on third data consisting of forward error correction coded first data and the payload CRC value based on offsets; and
generating frequency-hopped payload blocks by performing frequency hopping on the interleaved payload blocks according to a hopping sequence, and transmitting the frequency-hopped payload blocks.

11. The transmission method according to claim 10, wherein the generating of the interleaved payload blocks comprises:
dividing the third data into N data groups;
sequentially and respectively inputting values of the N data groups into N rows of an interleaver memory;
sequentially and respectively outputting the values input to the N rows in a column direction; and
performing cyclic shifts on the output values by using the offsets,
wherein N is a positive integer.

12. The transmission method according to claim 11, wherein the transmission device applies the offsets differently to the column direction for the respective N rows.

13. The transmission method according to claim 12, wherein the offset is determined as max{1, 48/n}, where n is an index of the payload block, is equal to or greater than 0, and is equal to or less than N−1.

14. The transmission method according to claim 11, wherein padding is added to at least one data group among the N data groups in order to equalize sizes of the N data groups.

15. The transmission method according to claim 14, wherein cyclic shifts using the offsets are applied to bits excluding the padding in the N data groups.

16. The transmission method according to claim 10, further comprising:
generating a packet header consisting of a synchronization word field, a physical header field, and a physical header CRC value field; and
performing frequency hopping on the packet header according to the hopping sequence, and transmitting the packet header,
wherein some bits of a physical header CRC value are mapped to a reserved field of the physical header field, and remaining bits of the physical header CRC value are mapped to the physical header CRC value field.

17. The transmission method according to claim 10, wherein in the transmitting of the frequency-hopped payload blocks, the frequency-hopped payload blocks are transmitted considering an idle period, wherein the idle period has a length equal to or greater than at least one symbol.
